(19) United States
(12) Patent Application Publication
(10) Pub. No.: US 2011/0305869 A1
(43) Pub. Date: Dec. 15, 2011

(54) VEHICLE OUTER SURFACE COMPONENT COMPRISING A GLASS LENS

(75) Inventors: Martin Pollak, Puchheim (DE); Adreas Strixner, Emmering (DE); Alexander Egger, Munchen (DE)

(73) Assignee: WEBASTO AG, Stockdorf (DE)

(21) Appl. No.: 13/145,717

(22) PCT Filed: Jan. 19, 2010
(86) PCT No.: PCT/EP10/00290

§ 371 Date: Aug. 30, 2011

(30) Foreign Application Priority Data
Jan. 27, 2009 (DE) 10 2009 006 300.5

(51) Int. Cl. B32B 3/12; B32B 15/04; B32B 21/04; B60R 13/00; B32B 5/00; B05D 1/30; B60R 21/00; B32B 9/04; B32B 29/00

(52) U.S. Cl. 428/116; 428/411.1; 428/457; 428/537.1; 428/537.5; 428/339; 427/420

(57) ABSTRACT

The invention relates to a vehicle outer surface component, which may be assembled on the outer surface of a vehicle, comprising a support structure with an outer skin having a lens of glass or a material similar to glass. According to the invention, a simple and economical production of such a vehicle outer surface component may be achieved whereby the support structure is a thermoplastic moulded piece or a lightweight composite structure and the outer skin of an at least partly transparent plastic is directly applied to the support structure by spray coating.

The invention relates to a vehicle outer surface component with the appearance of glass or an appearance similar to glass according to the preamble of patent claim 1.

DE 197 13 347 C5 discloses such a vehicle outer surface component serving as a draft deflector strip of an externally guided sliding roof, which is formed by a glass plate or a sheet of plastic fastened on a metal carrying frame. The sheet of plastic consists of a transparent, colored or tinted hard and wear-resistant material, such as polymethylmethacrylate (PMMA) or polycarbonate (PC). If the sheet of plastic is transparent or partially transparent, the desired shade of color to create a continuous appearance of glass over the entire vehicle roof can also be created by a lacquer film on the inner side of the sheet of plastic. The plate or sheet is fastened to the carrying frame for example by means of adhesive bonding or clipping. Alternatively, such vehicle outer surface components may also already be produced with a carrier part of plastic, which is produced for example by the Long Fiber Injection process (LFI process) or by the Compound Spray Molding process (CSM process) and an outer skin film laminated onto this carrier part. DE 195 05 006 C1 discloses a similar vehicle outer surface component that serves as a draft deflector strip for a large glass sliding roof.

DE 10 2005 013 974 A1, DE 10 2006 019 007 B3 and DE 10 2006 048 252 B3 disclose a process originating from Krauss-Maffei Kunststofftechnik GmbH for producing a composite component (the SkinForm® trademark has also been registered by Krauss-Maffei Kunststofftechnik GmbH for the machines that are used for carrying out the process). In this process, an outer layer of thermoplastic polyurethane (TPU) is flow-coated onto the carrier component formed by a thermoplastic shaped part. The flow coating preferably takes place into a cavity of a mold in which, according to one variant, a vacuum has previously been created. The carrier component may be produced or preformed as a composite component beforehand in the same mold in which the flow coating with polyurethane is performed.

The vehicle surface components produced by means of the SkinForm® technology have so far only been used in the passenger compartment of the vehicle. The journal “Kunststoffe” [plastics] describes in its 3/2000 issue, pages 104-106, the use of a SkinForm® component for interior trim of a vehicle door on a Skoda Roomster. In its brochure “SkinForm®: Kosteneffizientes Veredeln von Thermoplastbauteilen mit Polyurethan im One-Shot-Verfahren” [SkinForm®: cost-efficient surface finishing of thermoplastic components with polyurethane by the one-shot process], published on the Internet, the Krauss-Maffei company describes as application examples a belt buckle covering for a safety belt, a switch plate, an interior door trim and a headrest covering. A brochure from Sarnamotive Schenk GmbH mentions as application examples in the automotive sector seat trim parts, backrest shells, airbag coverings, crash-relevant parts in the knee impact area, such as steering column casing, center consoles, side door trim and instrument panel coverings.

The invention is based on the object of providing a vehicle outer surface component of the type mentioned at the beginning that has a low weight and high stability and can be produced easily and at low cost.

This object is achieved by the features of patent claim 1. Advantageous refinements are specified in the subclaims.

Producing the outer skin in the way according to the invention by flow coating a thin layer of a glossy, wear- and scratch-resistant, UV-resistant, at least partially transparent plastic onto a carrying layer which is produced as a thermoplastic shaped part or as a composite lightweight construction, preferably in the same mold, allows vehicle outer surface components with great intrinsic stiffness and low weight to be provided, suitable for various uses as a vehicle outer surface component on vehicles. An intrinsically stiff and light thermoplastic shaped part or composite lightweight component forms a particularly suitable carrier structure into which connecting elements for the fastening thereof or for connection to neighboring components can be embedded during production. Further stiffening measures, such as for example the metal frame previously used, can be omitted. The use of a thermoplastic shaped part or a composite lightweight carrier structure allows it to have a complex geometry, so that there is great freedom of design for such vehicle outer surface components.

The outer skin of the vehicle outer surface component produced by flow coating a plastic, in particular polyurethane, may be made very thin, for example with a layer thickness of approximately 0.6 to 1 mm, in particular approximately 0.8 mm. It has a high abrasion resistance and scratch resistance and can be given a glass-like gloss by light polishing. The vehicle outer surface component can be made much thinner and lighter than before as a result of the high load-bearing capacity of the thermoplastic shaped part or composite lightweight component which forms the carrier structure on the inner side of the vehicle outer surface component. Altogether, the vehicle outer surface component according to the invention becomes much lighter with the same or even increased stability. The overall component thickness of the vehicle outer surface component can even be reduced. By reducing the component and simplifying the production process, a cost reduction can be additionally achieved thereby.

For the purposes of the invention, “composite lightweight construction” or “composite lightweight component” is understood as meaning a multilayer component formed from at least two, preferably at least three, interconnected layers of different materials from which the carrier structure is formed, at least one layer consisting of a material and/or an arrangement with a relatively great volume and relatively low weight.

The carrier structure may be formed “monolithically” as a composite lightweight component, for example from polyurethane with an embedded fiber reinforcement. Coming into consideration as fiber reinforcement are glass fibers, carbon fibers, natural fibers, such as for example sisal, hemp or flax, or synthetic fibers, such as for example aramid, either in the form of loose chopped fibers as an admixture for the polyurethane in a spraying, casting, foaming or injecting process in an open or closed mold, in the latter case also combined with a pressing operation following a spraying, casting or injecting operation, or the fiber reinforcement is used in the form of mats, woven or knitted fabrics or meshes for a layered structure, alternating as layers respectively with a layer of plastic, in particular a polyurethane layer.

An example of a “monolithic” structure of the carrying layer is a carrying layer produced from Baydur® of Bayer MaterialScience AG (Baydur® is a registered trademark of Bayer AG) by the PUR Composite Spray Molding process (CSM process), chopped glass fibers being fed in a metered manner from the outside to the sprayed jet of polyurethane introduced into an open mold. This is followed by the molding of the shaped part by foaming in the closed mold. The random distribution of the glass fibers imparts a high mechanical strength in all loading directions to a carrying layer produced in this way, and consequently provides high stiffness of the vehicle outer surface component with relatively low weight.

An example of a structure of a carrying layer with alternating layers as a composite lightweight component is created by another variant of the PUR Composite Spray Molding process (CSM process) for processing Multitec® (Multitec® is a registered trademark of Bayer AG). Here, chopped long fibers are likewise introduced together with the polyurethane mixture into an open mold. The polyurethane mixture is in this case applied in multiple layers—in a compact or foamed form and optionally reinforced or un-reinforced—and cures in an open mold at room temperature.

In a further variant of the PUR Composite Spray Molding process (CSM process), natural fiber mats, of hemp, sisal, flax, coconut or the like, sprayed with a special polyurethane spraying system, are pressed into thin-walled, extremely light shaped parts for a composite lightweight component as a carrying layer by using Baypreg® F (Baypreg® is a registered trademark of Bayer AG).

A further variant of a composite lightweight construction for the carrying layer is formed by a sandwich structure, in which a specifically lighter layer of a plastic, a foam and/or a honeycomb structure is arranged between a lower and an upper outer layer of plastic or lightweight metal.

An example of a sandwich structure of the carrying layer as a composite lightweight component with a layer of plastic arranged between a lower and an upper outer layer is the material Hylite® or Alubond® (both registered trademarks of ALCAN Singen GmbH) with outer layers of aluminum and a layer of polypropylene (PP). The polypropylene layer may also be substituted by another suitable light plastic with high strength, such as polyamide.

A further example of a sandwich structure of the carrying layer as a composite lightweight component is a honeycomb structure of paper or paperboard, metal or plastic, also known by the name “honeycomb structure”, in which a honeycomb structure formed between two closed outer layers by walls arranged perpendicularly in relation to the outer layers encloses cavities (“open honeycomb structure”). The vertical walls are permanently adhesively bonded in their regions adjacent to the outer layers, for example by a plastic sprayed on before assembly (as shown in DE 100 33 232 C2). An example of a lightweight metal honeycomb structure of this type is the material Alucore® (registered trademark of ALCAN Singen GmbH). Instead of the cavities, a solid core material, for example a plastic or a plastic foam or metal foam, may be arranged between the walls of the honeycomb structure (“closed honeycomb structure”). An open or closed honeycomb structure may finally also be joined together with the Baypreg® F described above, by spraying and pressing, to form a carrying layer.

The flow coating of the outer skin of the vehicle outer surface component preferably takes place in one mold, which, in a first process step, is also used for the production of the thermoplastic shaped part, for example by injection or injection molding, and in which, in a second process step, by slowly raising an upper mold part, a correspondingly shallow cavity is formed for creating the flow-coated outer skin of plastic.

The outer skin of the vehicle outer surface component may also be applied by the Clear Cold Molding process (CCM process) by flow coating onto an already finished carrier structure, which has been produced as a thermoplastic shaped part or as a composite lightweight component outside the mold used for the flow coating.

In the shallow cavity into which the liquid plastic for creating the outer skin is flow-coated, a vacuum or partial vacuum may be created before the flow coating, whereby a uniform, completely bubble-free thin outer skin of high quality is created.

The flow-coated outer skin may be applied to a planar or curved surface of the thermoplastic shaped part or of the composite lightweight component.

Vehicle outer surface components according to the invention may be used, for example, for roof modules without opening systems, roof modules with opening systems (sliding roofs, lifting roofs, sliding/lifting roofs, externally guided sliding roofs, panoramic roofs, spoiler roofs, lamella roofs, retrofitted roofs and the like), for covers of roof opening systems, for roof shells of roofs for hardtop convertibles (also known as “Retractable Hardtops”=“RHTs”), for draft deflector strips, for spoilers, for rear lids, engine hoods, doors or fenders as well as for the outer trim of the A, B, C and D pillars.

The invention is explained in more detail below on the basis of exemplary embodiments of vehicle surface components according to the invention with reference to the drawing, in which:

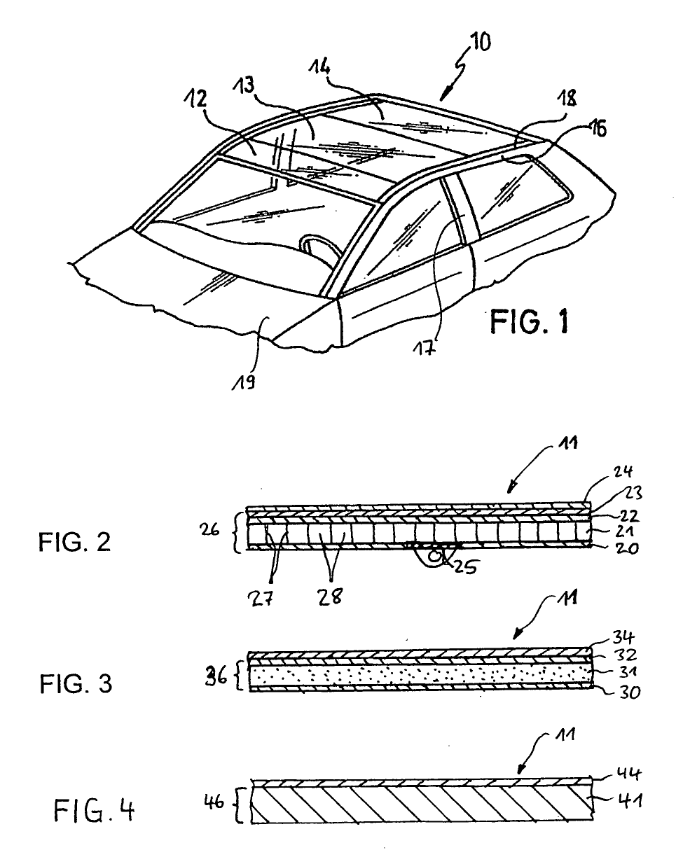

FIG. 1 shows a perspective plan view of the upper part of a vehicle with vehicle outer surface components according to the invention;

FIG. 2 shows a vehicle outer surface component according to a first embodiment in a cross-sectional view;

FIG. 3 shows a vehicle outer surface component according to a second embodiment in a cross-sectional view; and

FIG. 4 shows a vehicle outer surface component according to a third embodiment in a cross-sectional view.

A vehicle 10, such as for example a passenger car (see FIG. 1), has adjoining the rear of the front windshield a draft deflector strip 12, which may also take the form of a fixed roof part with the appearance of glass, a first roof panel 13, which can be moved by raising/lowering or displacing or else is fixedly arranged, and a second roof panel 14, which can be moved by raising/lowering or displacing or else is fixedly arranged. The vehicle roof is laterally bounded by side beams 16. Arranged between the side beams 16 and the roof panels 13, 14 or the draft deflector strip is a cover strip 18, which covers the welding recesses of the body for connecting the roof to the side parts and/or a mount or guide for the roof panels 13 or 14. The draft deflector strip 12, the roof panels 13 and 14 and the cover strip 18 form potential vehicle outer surface components 11 with the appearance of glass or an appearance similar to glass as provided by the present invention. They may, however, also be partially produced from glass. Further potential vehicle outer surface components 11 that are represented in FIG. 1 are formed by a B pillar covering 17 and an engine hood 19. However, other outer surfaces of the vehicle 10, such as doors, fenders, baggage-compartment lids, spoilers or bumper modules may also be produced as vehicle outer surface components 11 with the appearance of glass or an appearance similar to glass as provided by the invention.

An enlarged detail of a vehicle outer surface component 11 according to the invention is shown in cross section in FIGS. 2 to 4.

The vehicle outer surface component 11 according to FIG. 2 is produced in the manner of a lightweight construction with a carrier structure 26 of a composite lightweight component in a sandwich-like layered structure and contains, from the inside outward, a first inner carrying layer 20, as the lower cover layer, a core layer or spacer layer 21, formed as a honeycomb structure with walls 27 arranged perpendicularly to the carrying layers 20, 22 and cavities 28 lying in between, a second outer carrying layer 22, as the upper cover layer, and a decoupling layer 23. This carrier structure 26 is produced, for example, by the Composite Spray Molding process (CSM process). An outer skin 24 of a wear- and scratch-resistant, UV-resistant, at least partially transparent plastic, applied to the carrier structure 26 by flow coating in a layer thickness of, for example, approximately 0.8 mm, covers the vehicle outer surface component 11 toward the outside. The plastic of the outer skin 14 is formed, for example, by transparent polyurethane, which after light polishing has a glossy surface with the appearance of glass or an appearance similar to glass.

The carrying layers 20 and 22 preferably consist of polyurethane (PU) with a weight per unit area of approximately 300 g/m², which is optionally and preferably reinforced respectively by means of a glass fiber mat with a weight per unit area of approximately 225 g/m².

The core layer or spacer layer 21 preferably consists of a honeycomb structure and in particular of a paper, plastic or aluminum honeycomb, for example with a thickness of approximately 13 mm, the corrugation and sheet of the honeycomb structure having in the case of a paper honeycomb a weight per unit area of in each case approximately 115 g/m².

The decoupling layer 23 preferably has a thickness of approximately 2 to 2.5 mm. It serves the purpose of effectively preventing a visible impression of the honeycomb structure appearing on the outer skin 24 that could otherwise occur during compression in a mold if the decoupling layer 23 were not provided.

The layered structure, comprising the core layer or spacer layer 21 and the two neighboring carrying layers and 22, is produced by means of the CSM process (composite spray molding), which is known from Hennecke GmbH, D-53754 Sankt Augustin, in a mold (CSM mold). The layered structure is also represented in a similar form in DE 100 33 232 C2. With very low weight, the strength of the layered structure is achieved in particular by the plastic, preferably polyurethane (PU), penetrating into the region of the vertical walls 27 of the honeycombs and bonding with them.

On the inner side of the vehicle outer surface component 11, inserts 25 of metal, which, by means of clips, bores, threaded inserts or the like, serve for fastening to neighboring components, such as for example to roof frames, roof mechanisms (in the case of movable roof panels), beams, pillars or the like or for fastening neighboring components, such as for example sun visors or grab handles, may be embedded, for example, in the first carrying layer 20, serving as the lower cover layer.

This basic structure may be modified and, for example, supplemented by at least one additional layer, such as for example a shatterproof layer (not represented) between the first carrying layer 20 and the core layer 21 and possibly between the core layer or spacer layer 21 and the second carrying layer 22.

FIG. 3 shows a second embodiment of a movable or immovable vehicle outer surface component 11. The vehicle outer surface component 11 consists from the top downward, or from the outside inward when in its functional position, of:
an outer skin 34 of a flow-coated weather-resistant, UV-stable and scratch-resistant plastic, preferably transparent polyurethane, with a layer thickness of approximately 0.8 mm,
a metal layer 32, in particular an aluminum layer,
a layer of plastic 31, for example of polypropylene (PP) or polyamide (PA), as a spacer layer; and
a metal layer 30, in particular an aluminum layer.

The metal layers 30 and 32 and the layer of plastic 31 lying between them form a carrier structure 36, onto which the outer skin 34 is flow-coated. The carrier structure 36 may be formed for example from a composite lightweight component, such as Hylite® or Alubond® (both registered trademarks of ALCAN Singen GmbH), which is preferably brought into the desired shape by pressing before the flow coating of the outer skin 34 in a mold and is preferably uniformly flow-coated over with the plastic of the outer skin 34 in the same mold by creating a correspondingly shallow cavity in the Clear Cold Molding process (CCM process).

In the exemplary embodiment according to FIG. 4, the vehicle outer surface component 11 is formed by a carrier structure 46 and an outer skin 44 flow-coated onto it. The carrier structure 46 consists in this example of a thermoplastic shaped part which has been produced for example by injection molding in a mold, for example in a SkinForm® mold (SkinForm® is a registered trademark of Krauss-Maffei Technologies GmbH), after which the outer skin 44, preferably of a transparent thermoplastic polyurethane (TPU), is flow-coated onto the carrier structure in a layer thickness of approximately 0.8 mm in a following process step in the same mold. The shallow cavity formed for this purpose in the mold is preferably evacuated before the flow coating of the outer skin 44 to create a vacuum, or at least a partial vacuum, so that the plastic flowing into the cavity forms a uniformly smooth, glossy layer with the appearance of glass or an appearance similar to glass.

After the flow coating of the outer skin 44, the vehicle outer surface component 11 is removed from the mold and the sprue of the plastics material of the outer skin 44 is removed. The outer skin 44 may additionally be polished to create an enhanced appearance of glass or appearance similar to glass.

The molds required for production are described in detail in the documents cited at the beginning from the companies Krauss-Maffei and Sarnamotive Schenk GmbH. They do not constitute part of the present invention and are therefore not described in any more detail in this application.

The invention is not restricted to the exemplary embodiment specified. It is thus possible in particular to combine the features of the various exemplary embodiments with one another, so that such arrangements are also covered by the invention.

### LIST OF DESIGNATIONS

10 vehicle
11 vehicle outer skin component
12 draft deflector strip
13 roof panel
14 roof panel
16 side beam
17 B-pillar covering
18 cover strip
19 engine hood
20 inner carrying layer
21 core layer (spacer layer)
22 outer carrying layer
23 decoupling layer
24 outer skin
25 insert
26 wall
28 cavity
30 metal layer
31 layer of plastic (spacer layer)
32 metal layer
34 outer skin
36 carrier structure
41 thermoplastic shaped part
44 outer skin
46 carrier structure

1. Vehicle outer surface component, which can be attached in exterior arrangement to a vehicle, which has a carrier structure and an outer skin connected thereto with the appearance of glass or an appearance similar to glass,
wherein
the carrier structure is produced as a thermoplastic shaped part or as a composite lightweight construction, and the outer skin of an at least partially transparent plastic is applied directly to the carrier structure by flow coating.

2. The vehicle outer surface component as claimed in claim 1, wherein
the carrier structure is produced as a multilayered composite component.

3. The vehicle outer surface component as claimed in claim 1, wherein
the carrier structure is produced as a sandwich composite component.

4. The vehicle outer surface component as claimed in claim 3, wherein
the sandwich composite component has a honeycomb structure with walls bounding the honeycombs and cavities lying between the walls.

5. The vehicle outer surface component as claimed in claim 1, wherein
the carrier structure has at least one layer of a sheet-like panel or film, which consist at least partially of metal and/or of plastic and/or of wood and/or of paper or paperboard.

6. The vehicle outer surface component as claimed in claim 1,
wherein
at least part of the carrier structure is produced by a plastics spraying process, a plastics spraying-pressing process or a plastics injection process, in particular by the Composite Spray Molding process (CSM) and/or by the Reaction Injection Molding process (RIM) and/or by the Long Fiber Injection process (LFI).

7. The vehicle outer surface component as claimed in claim 1,
wherein the outer skin is formed from polyurethane (PU).

8. The vehicle outer surface component as claimed in claim 1
wherein the outer skin has a thickness of approximately 0.6 to 1.0 mm, in particular of approximately 0.8 mm.

9. The vehicle outer surface component as claimed in claim 1,
wherein the vehicle outer surface component can be used for roof modules without opening systems, roof modules with opening systems such as sliding roofs, sliding/lifting roofs, panoramic roofs, spoiler roofs, lamella roofs, retrofitted roofs, for covers of roof opening systems, for roof shells of roofs for hardtop convertibles (also known as “Retractable Hardtops”=“RHTs”), for draft deflector strips, for spoilers, for rear lids, for engine hoods, for doors or fenders as well as for A, B, C and D pillar coverings.
